(19) United States
(12) Patent Application Publication
(10) Pub. No.: US 2014/0039904 A1
(43) Pub. Date: Feb. 6, 2014

(54) DATA EDITING AND APPROVAL FUNCTION IN CLINICAL SUPPLIES IVRS SYSTEMS

(71) Applicants: Manish Kumar, King of Prussia, PA (US); Kainan Yin, Blue Bell, PA (US); Christine Matakovich, Schwenksville, PA (US); Mihai Petcov, King of Prussia, PA (US); Stephen Patches, Manheim, PA (US)

(72) Inventors: Manish Kumar, King of Prussia, PA (US); Kainan Yin, Blue Bell, PA (US); Christine Matakovich, Schwenksville, PA (US); Mihai Petcov, King of Prussia, PA (US); Stephen Patches, Manheim, PA (US)

(73) Assignee: ORACLE INTERNATIONAL CORPORATION, REDWOOD SHORES, CA (US)

(21) Appl. No.: 13/562,467

(22) Filed: Jul. 31, 2012

(51) Int. Cl. G06Q 50/22

(52) U.S. Cl. 705/2

(57) ABSTRACT

Systems, methods, and other embodiments associated with data editing in a web-based interactive web response system are described. In one embodiment, a method includes receiving a request to perform an edit on a data field over a web-based protocol. The request is sent to an approval function that accesses stored authorization data to select an approval level associated with the data field. The approval function also determines an authorized approver mapped to the approval level to generate a notification over the web-based protocol. The notification is transmitted to at least one authorized approver over the web-based protocol. Approval to perform the edit is received from the at least one authorized approver over the web-based protocol.

### BACKGROUND

A blind or blinded experiment is a clinical study or scientific experiment where some of the people involved are prevented from knowing certain information that might lead to a conscious or subconscious bias on their part. Blinding can be imposed on researchers, technicians, subjects, funders, or any combination therein. For example, in a clinical drug trial, the researchers and patients may be prevented from knowing which patients are being treated with a drug versus a placebo. While clinical interactive voice response (IVR) and interactive web response (IWR) systems, used for patient randomization and clinical supplies management, are designed to maintain a blind study during initial data entry, the downstream effects of changing or editing the data may reveal whether the subject was dosed with the drug or the placebo or bias the people involved in another manner. For example, changing the weight of a subject may cause a change in dosage of the drug, but not the placebo, such that the administering clinician would know whether the subject was on the drug or placebo.

Furthermore, editing data that has been entered into the system can lead to corruption of the downstream data. Therefore, data editing is restricted to protect against errors being propagated through the data. Typically, a user editing data will contact a software support agent to make a correction. The software support agent will evaluate the change and work with clinical study administrators to get approval to make the change. If the change is approved, the software support agent will write a database query to make the change. A second software support agent reviews the change. If the change is correct, a query is executed on the relevant data in the database. This process suffers from significant delays and is very resource intensive.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a method associated with data editing in a web-based interactive web response system.

FIG. 2A illustrates one embodiment of a method associated with data editing in a web-based interactive web response system.

FIG. 2B illustrates one embodiment of a method associated with data editing in a web-based interactive web response system.

FIG. 3 illustrates one embodiment of a method associated with deploying a web-based interactive web response system capable of editing.

FIG. 4 illustrates one embodiment of a screen shot associated with data editing in a web-based interactive web response system.

FIG. 5 illustrates one embodiment an example of a computing system in which example methods, systems, and equivalents may operate.

### DETAILED DESCRIPTION

Systems and methods are described herein that provide support for the life sciences, pharmaceutical, and medical device companies in the tracking and reporting of clinical trial subject randomization and clinical supply inventory management. Specifically, the system communicates and approves data edits in a manner that protects patients and protects against inadvertent corruption of data that compromises the blinded nature of the study. Often clinical data is used in treatment and drug allocation.

Editing the clinical data may be of a critical nature to the clinical trial and require immediate action. The system provides an automated web-based procedure that allows a user to edit field values. Further functionality allows authorized approvers (e.g., administrators) to approve or reject changes for specific field values that have been allocated for approval during editing. Authorized approvers may also take actions such as removing a subject's results from the final data analysis (e.g., screening failure, early termination), if, for example, the subject breached protocol.

Editing clinical data in clinical trials (e.g., studies, experiments, tests, visits) is performed for a variety of reasons (e.g., corrections, rollbacks). Corrections may be necessary due to typographical errors, misreading data, or faulty equipment. A correction will change a specific field. Rollbacks are designed to correct substantial data entry errors that significantly impact the outcome of the data and downstream fields. One of the leading causes of rollbacks is due to visit back-outs. A visit back-out is used to remove clinical data incorrectly linked to a given subject, when the visit actually pertains to a different subject. One reason this may occur is if the incorrect subject identifier is entered during transactions with a subject.

Clinical trials are progressive such that data entered in one visit may be used in a subsequent visit. For example, data entered in a screening visit may be used to determine drug dosage in later visit. To ensure that data edits do not propagate mistakes through downstream clinical data, communications between the system and the authorized approvers that approve edits are automatically sent via the web-based system to reduce the number of mistakes and manual transmissions. Offline and email communications may lead to missing information, such as the identity of an authorized approver, authorized approver's comments, and whether a protocol was followed. In the web-based system, changes and approvals are logged into the system. Accordingly, edits can be made without unblinding the clinical study or propagating errors downstream.

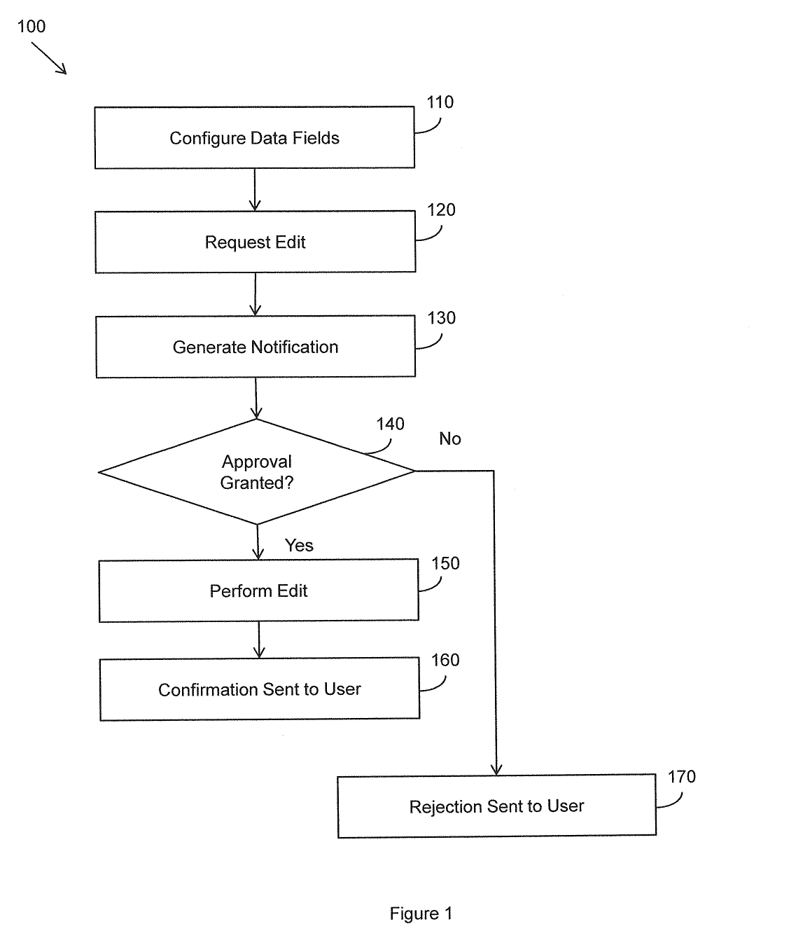

With reference to FIG. 1, one embodiment of a method 100 associated with editing data in clinical trials is illustrated. The method 100 is performed in a web based application used for managing clinical studies. Web-based protocol handlers allow web-based applications to operate online.

Furthermore, by operating online the functionality of method 100 can occur in real-time and send and receive immediate responses.

At 110, a user employs the web-based interactive web response system to configure data fields in a clinical study. Alternatively, data may be entered over the telephone to data entry personnel. The clinical study has a number of data fields configured to receive data. The data fields may include subject data or drug dispensation data. Subject data typically determines drug and dose (e.g., subject's initials, gender, weight, blood pressure, age). Drug dispensation may identify a particular drug. A data field is also configured with an authorized approver. The authorized approver determines the users that can change the data entered in the data field. A data field may be correlated with an authorized approver based on the authorized approver's identity, position, clearance, or other characteristics.

At 120, a user requests to edit a data field. The user may be attempting to correct data entered in the selected field or perform a rollback. In one example, a user is a clinician who has entered an incorrect weight for a subject. In response to the user requesting an edit at 120, a notification is automatically generated at 130. The web based application transmits a notification requesting approval to make the edit to the authorized approver. The notification includes information about the requested edit. For example, the notification may include the erroneously entered data, the corrected data, the reason for the edit, and/or identify any data fields that would be affected by approving the edit.

At 140, it is determined whether approval is granted by the authorized approver. In response to the approval being granted at 140, the requested edit is performed at 150. At 160, a confirmation is sent to the user confirming that the edit has been made. Conversely, if approval for the requested edit is not granted, a rejection is sent to the user. Approval is withheld due to security concerns, to safeguard the study, or protect the integrity of the study. For example, approval may be withheld based on the user's clearance level, the downstream effect of making the requested edit, or data that may be inadvertently revealed due to making the requested edit.

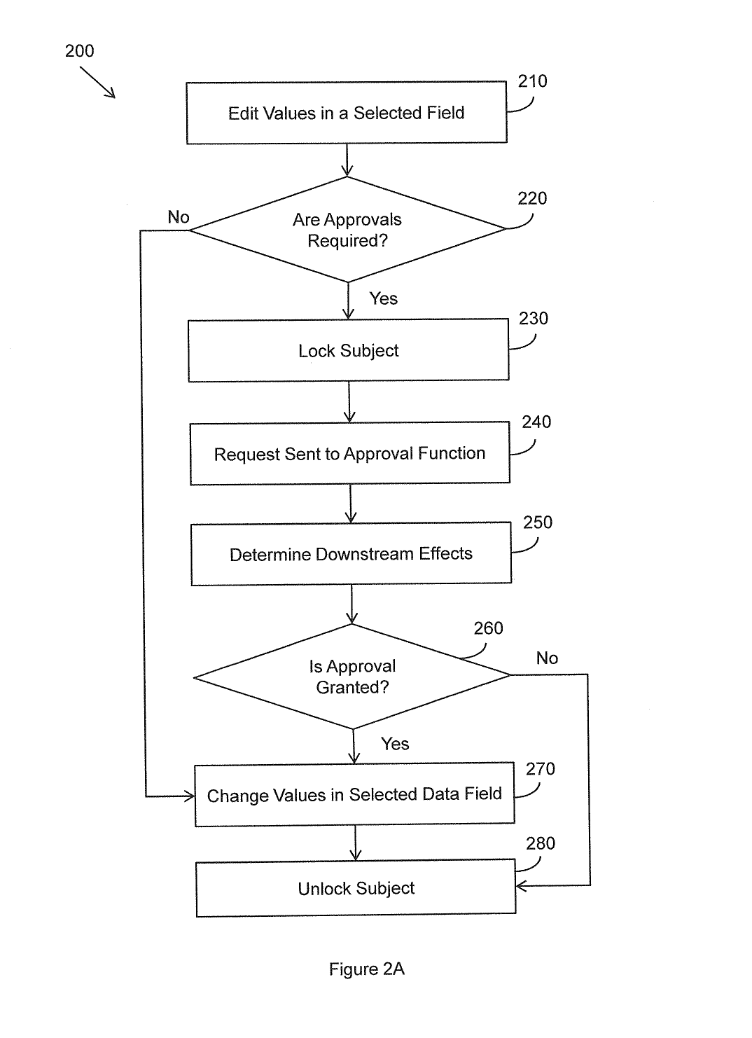

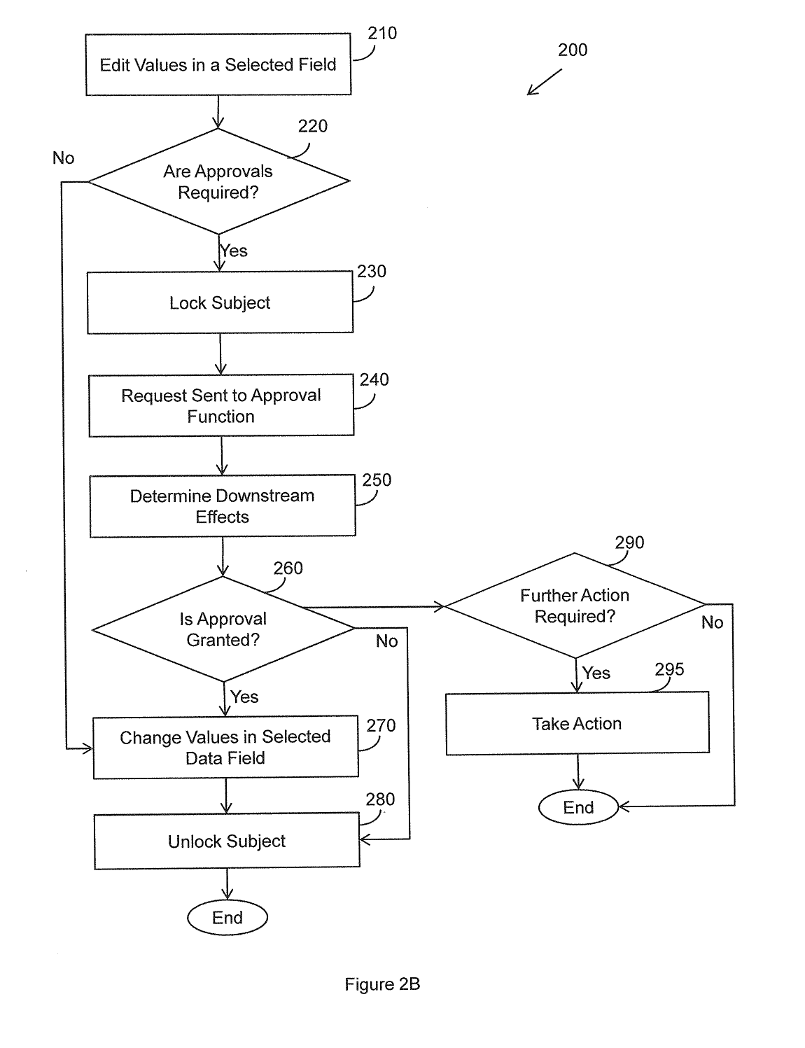

FIG. 2A illustrates one embodiment of a method associated with data editing in a web-based interactive web response system. At 210, the method initiates with a user attempting to edit data in a selected field in a clinical trial. For example, the method 200 is initiated at 210 when the user attempts to correct the weight of the subject in the relevant selected field. The attempt to edit values in data fields in the clinical study triggers automatic communications between the system and the authorized approvers that approve edits.

At 220, it is determined whether approval from an authorized approver is required. The selected field may be associated with metadata to indicate that approvals are required to make edits. Alternatively, the selected field may be tagged or have a flag to indicate that approvals are required to make edits. If approvals are not required, the values of the selected field are edited. If approvals are required, the fields related to the subject, including the selected field, are locked at 230. When the fields related to the subject are locked, data cannot be added, edited, or deleted relevant to the subject. Locking the subject prevents data from being introduced while the editing process is underway. Locking can be over-ridden in the event of a pre-determined occurrence. For example, in the event that a subject suffers a serious adverse effect, physicians and authorized approvers can access fields related to the subject.

At 240, a request is sent to an approval function. The approval function identifies and automatically generates alerts to be sent to one or more authorized approvers that have the authority to approve edits. In one example, the selected field is assigned to a particular authorized approver for approval. Alternatively, any editing that pertains to a certain subject may be assigned to a particular authorized approver. There may be multiple levels of approval. For example three authorized approvers may receive notifications simultaneously or serially for approval of the requested edit. The authorized approver is sent an alert that an edit on the selected field has been attempted via a web-based protocol. Web-based protocols allow web-based applications to perform the method 200.

At 250, the system determines downstream effects by identifying any fields that are dependent from the selected field being edited. The dependent fields are fields that have values that may change or need to be changed based on the selected field being edited. In the example given above, the dosage given to the subject may be affected by the weight of the subject. Accordingly, the dosage field is a dependent field to the weight field. The system may be programmed to identify dependent fields or dependency may be determined during the setup of the clinical trial. Fields may be identified as dependent fields using metadata or tagging.

At 260, it is determined whether approval is granted by the authorized approver. If the approval is granted, the requested edit is made to the selected data field at 270. The subject's data is then unlocked at 280 so further data can be added, edited, or deleted relevant to the subject. If the approval is not granted, the subject's data is unlocked at 280 without the edit being performed for the selected data field.

FIG. 2B illustrates one embodiment of a method 200 associated with data editing in a web-based interactive web response system. FIG. 2B has similar steps as FIG. 2A. Steps of FIG. 2B having the same reference numbers of steps in FIG. 2A, have similar functionality.

After determining downstream effects by identifying any fields that are dependent from the selected field being edited at 250, the method 200 may both determine whether approval is granted by the authorized approver at 260 and determine whether further reaction is required 290. In this manner, method 200 is capable of parallel processing. For example, the further reaction required may be flagging a subject for review, determining whether a drug the subject is on the correct drug, or determining whether a drug meets specifications. If it is determined that further action is required at 290, action is taken at 295. If further reaction is not required at 290, the method 200 ends.

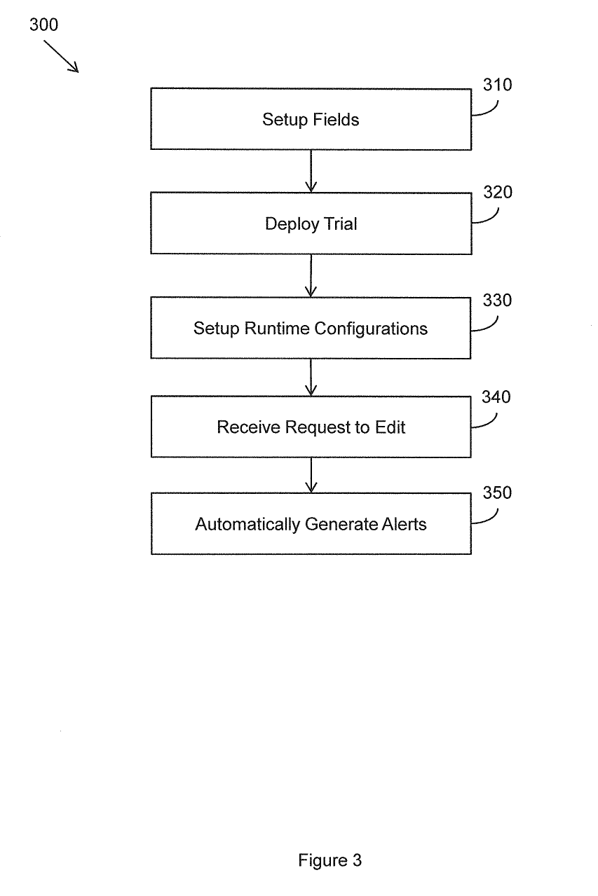

FIG. 3 illustrates a method 300 associated with one embodiment of deploying a clinical trial application capable of editing. Method 300 includes, at 310, setting up fields in a clinical study. The fields may include fields such as a subject identifier, genotype characteristics, phenotype characteristics, and treatment details. Furthermore, the data fields are tagged to allow or disallow editing. For example, the fields may have designated “Yes or No” options or an editing flag. The system is set to default as all editing options set to yes.

A dependency relationship is set up between the fields. The dependencies may be determined by an authorized approver. The authorized approver may tag fields as a dependent to a selected field. The tags are stored in a database table that is accessed using the web based protocol. Alternatively, the dependent fields have metadata indicating that the dependent fields depend from a particular field. Once the fields have been setup, the clinical trial application is deployed at 320.

Method 300 includes, at 330, setting up the runtime configuration. The runtime configuration prompts the user to define the authorized approver roles and identify the authorized approvers that have authorization to approve the edits to the data field values. The configuration prompts allow an authorized approver to select or set who may perform data editing, such as the edit of individual data points, allowing a rollback, or setting acknowledgment of drug reallocation. There are multiple levels of approvals regarding authorized approvers (e.g., no approval, one approval, two approvals) that can be selected. At 340, a request is received to edit a selected field of data. The authorized approver having the authorized approver role to edit the selected field is alerted at 350. The alert is automatically generated as a response to the request. The alert is transmitted to the authorized approver over a web-based protocol.

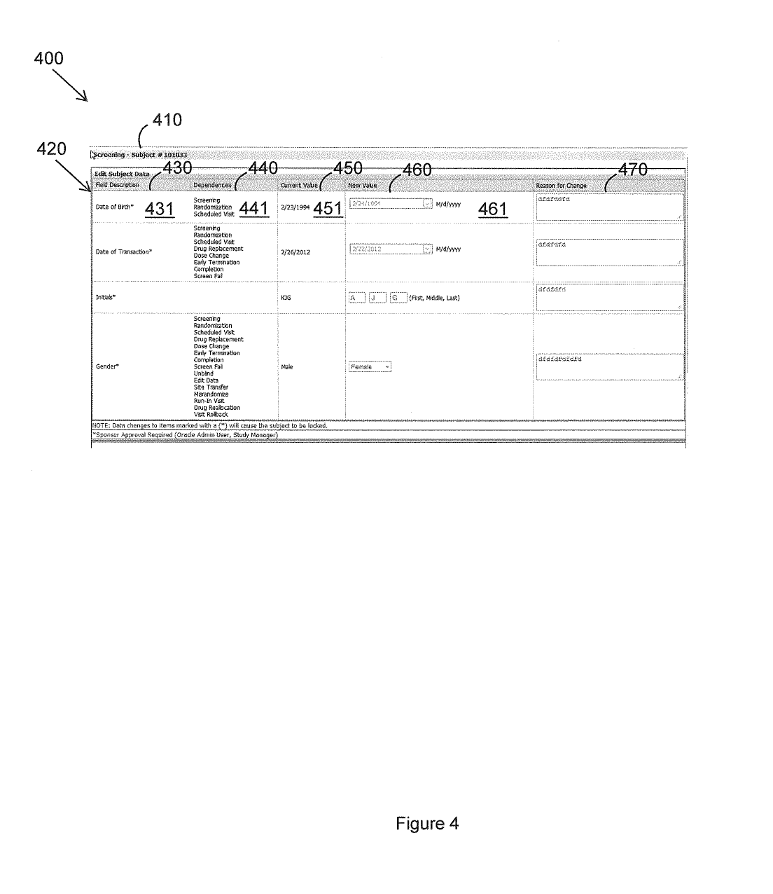

FIG. 4 illustrates one representation of a screenshot of a web-based editing tool (e.g., interactive web response system) according to an embodiment of the present invention shown as a tabular worksheet 400. The tabular worksheet 400 pertains to a specific subject 410 identified as #101033.

Editable subject data 420 are organized in the tabular worksheet in rows and columns. Field description column 430 describes the data in the field that can be edited. For example, the Date of Birth 431 can be edited. Dependence column 440 describes the downstream fields of data that are affected by the data field to be edited. With respect to the Date of Birth 431, a change of the Date of Birth 431 data field would affect downstream fields 441 (e.g., screening, randomization, scheduled visit). Current Value column 450 shows the currently entered value for the described field. Thus, at 451 the subject's birthday is Feb. 23, 1994. New Value column 460 has an open data entry field where a user can edit data. With respect to the subject's birthday, a new value 461 has been entered as Feb. 24, 1994. The user can also enter a reason for the edit in the Reason for change column 470.

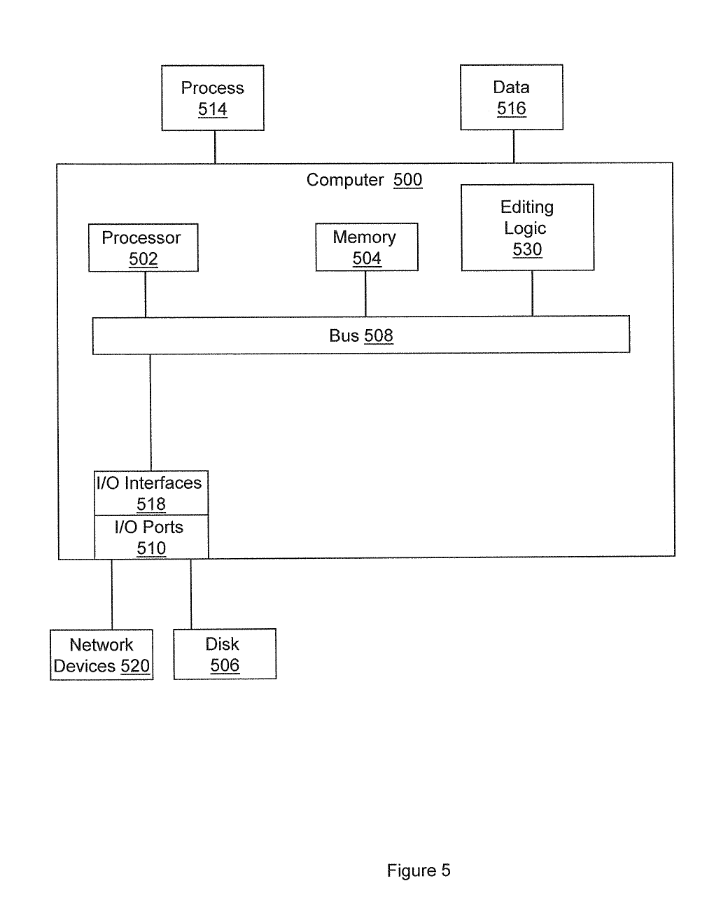

FIG. 5 illustrates an example computing device in which example systems and methods described herein, and equivalents, may operate. The example computing device may be a computer 500 that includes a processor 502, a memory 504, and input/output ports 510 operably connected by a bus 508. In one example, the computer 500 may include an editing logic 530 configured to facilitate data editing in a web-based interactive web response system. In different examples, the editing logic 530 may be implemented in hardware, a non-transitory computer-readable medium with stored instructions, firmware, and/or combinations thereof. While the editing logic 530 is illustrated as a hardware component attached to the bus 508, it is to be appreciated that in one example, the editing logic 530 could be implemented in the processor 502.

In one embodiment, logic 530 is a means (e.g., hardware, non-transitory computer-readable medium, firmware) for configuring data fields in clinical trial. The editing logic 530 handles requests for edits from users and generates notifications to authorized approvers who approve the requested edits. Furthermore, the editing logic performs the requested edit and sends confirmations to the requestor.

The means may be implemented, for example, as an ASIC programmed to facilitate data editing in a web-based interactive web response system. The means may also be implemented as stored computer executable instructions that are presented to computer 500 as data 516 that are temporarily stored in memory 504 and then executed by processor 502.

The editing logic 530 may also provide means (e.g., hardware, non-transitory computer-readable medium that stores executable instructions, firmware) for determining if approvals are required to make a requested edit. The editing logic 530 also identifies any fields that are dependent from the selected field being edited. Furthermore, the editing logic 530 may lock and unlock data fields related to the subject to prevent data from being introduced while the editing process is underway.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The bus 508 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The computer 500 may interact with input/output devices via the i/o interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and USB ports.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the methods shown in FIGS. 1-3.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

PCI: peripheral component interconnect.

PCIE: PCI express.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

SQL: structured query language.

OQL: object query language.

USB: universal serial bus.

XML: extensible markup language.

WAN: wide area network.

“Computer component”, as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

In some examples, “database” is used to refer to a table. In other examples, “database” may be used to refer to a set of tables. In still other examples, “database” may refer to a set of data stores and methods for accessing and/or manipulating those data stores.

“Data store”, as used herein, refers to a physical and/or logical entity that can store data on a non-transitory computer readable medium. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, a non-transitory computer readable medium that stores instructions, instructions in execution on a machine, and/or combinations of each to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“User”, as used herein, includes but is not limited to one or more persons, computers or other devices, or combinations of these.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A non-transitory computer-readable medium storing computer-executable instructions that when executed by a computer cause the computer to perform a method, the method comprising:
receiving a request to perform an edit on a data field over a web-based protocol;
sending the request to an approval function that accesses stored authorization data to select an approval level associated with the data field and determines an authorized approver mapped to the approval level to generate a notification over the web-based protocol;
transmitting the notification to the authorized approver over the web-based protocol; and
receiving approval to perform the edit from the authorized approver over the web-based protocol.

2. The non-transitory computer-readable medium of claim 1, further comprising locking the data field to prevent data from being introduced while performing the edit to the data field.

3. The non-transitory computer-readable medium of claim 1, where the approval function is configured to determine downstream data effects of performing the edit on the data field and to communicate the downstream data effects in the notification.

4. The non-transitory computer-readable medium of claim 1, further comprising performing the edit on the data field in response to receiving approval to perform the edit.

5. The non-transitory computer-readable medium of claim 2, further comprising:
performing the edit on the data field; and
unlocking the data field in response to the edit being performed.

6. The non-transitory computer-readable medium of claim 1, further comprising configuring data fields with an authorized approver prior to deployment of a clinical study, wherein the editing is associated with the clinical study.

7. The non-transitory computer-readable medium of claim 1, where a first notification is sent to a first authorized approver and a second notification is sent to a second authorized approver.

8. The non-transitory computer-readable medium of claim 7, where the second notification is sent in response to receiving approval from the first authorized approver.

9. The non-transitory computer-readable medium of claim 1, further comprising setting up runtime configurations to define authorized approver roles and identify the authorized approvers that have authorization to approve the edits to the data field.

10. A method, comprising:
generating data fields for a clinical trial;
mapping the data fields to authorization data that includes authorized approver levels, where an authorized approver level identifies at least one authorized user capable of determining whether a data field can be edited;
tagging the data fields using metadata to identify downstream data fields that would be affected by editing of the data field;
deploying the clinical study;
receiving a request to perform an edit on a data field over a web-based protocol; and
sending the request to an approval function that accesses the authorization data to select an approval level associated with the data field and generates a notification over the web-based protocol.

11. The method of claim 10, where the authorized approval level indentifies a first authorized user and a second authorized user.

12. The method of claim 11, where a first notification is sent to the first authorized user and a second notification is sent to the second authorized user.

13. The method of claim 12, wherein the second notification is sent in response to receiving approval from the first authorized user.

14. A non-transitory computer-readable medium storing computer-executable instructions that when executed by a computer cause the computer to perform a method, the method comprising:
configuring data fields in a clinical trial;
mapping the data fields to authorization data that includes authorized approvers capable of determining whether a data field can be edited;
populating a subject data table with the subject data using a web based protocol;
receiving a request to perform an edit on a data field over a web-based protocol;
sending the request to an approval function that accesses the authorization data to select an authorized approver associated with the data field;
generating a notification over the web-based protocol; and
transmitting the notification to the authorized approver over the web-based protocol.

15. The non-transitory computer-readable medium of claim 14, where configuring data fields includes identifying downstream data fields of a selected data field that would be affected by the selected data field being edited.

16. The non-transitory computer-readable medium of claim 14, further comprising receiving approval to perform the edit from the authorized approver over the web-based protocol.

17. The non-transitory computer-readable medium of claim 14, where the approval function is further configured to determine downstream data effects of performing the edit on the data field and to communicate the downstream data effects in the notification.

18. The non-transitory computer-readable medium of claim 14, further comprising performing the edit on the data field in response to receiving approval to perform the edit.

19. The non-transitory computer-readable medium of claim 14, where the authorization data further comprises authorized approver levels and authorized approver roles.

20. The non-transitory computer-readable medium of claim 19, where the authorized approver levels specify more than one authorized approver is associated with the data field.
